(19) United States
(12) Patent Application Publication
(10) Pub. No.: US 2018/0156246 A1
(43) Pub. Date: Jun. 7, 2018

(54) PNEUMATIC ACTUATORS FOR SEVERABLE LINKAGE ASSEMBLIES

(71) Applicant: Sikorsky Aircraft Corporation, Stratford, CT (US)

(72) Inventor: Bradley M. Bauer, Middletown, CT (US)

(21) Appl. No.: 15/572,729

(22) PCT Filed: May 11, 2016
(86) PCT No.: PCT/US16/31753

§ 371 Date: Nov. 8, 2017

Related U.S. Application Data
(60) Provisional application No. 62/164,009, filed on May 20, 2015.

(51) Int. Cl. F15B 15/14; B64C 25/56; F15B 15/24; F15B 13/02

(52) U.S. Cl. CPC F15B 15/1409; B64C 25/56; B64C 2025/325; F15B 15/24; F15B 13/027; F15B 15/1457

(57) ABSTRACT

A de-linking assembly includes an actuator defining a chamber and an inlet, a piston slideably disposed within the chamber, link coupled to the actuator, and a ram disposed between the piston and the link. The link defines a stress concentration features and a load point on a side of the link on a side of the stress concentration feature opposite the actuator. The ram is seated to the piston and against the load point such that air introduced into the chamber through the inlet applies force to the piston and ram sufficient to sever the link by inducing stress in the stress concentration feature.

### CROSS REFERENCE TO RELATED APPLICATION

This application claims priority to and benefit of U.S. Provisional Application No. 62/164,009, filed May 20, 2015, which is incorporated by reference herein in its entirety.

### BACKGROUND OF THE INVENTION

### 1. Field of the Invention

The present disclosure relates to linkages, and more particularly to actuators for de-linking severable linkages.

### 2. Description of Related Art

Aircraft commonly include severable linkages such as explosive bolts, cable cutters for hoist systems, canopy release mechanisms, and door jettison mechanisms that are operable to rapidly disconnect structural elements otherwise integral with the aircraft. Some aircraft, such as aircraft operated in marine environments, include flotation devices that can be deployable from the aircraft to provide stability to the aircraft in the event of a water landing. The flotation devices are generally stowed within the aircraft airframe in a deflated state in proximity to a source of inflation gas, such as a compressed gas bottle containing compressed air or nitrogen. In preparation for a water landing the door to the compartment housing the flotation device is released and the gas source coupled to the flotation device such that the flotation device inflates externally from the aircraft while coupled to the aircraft, thereby providing buoyancy to the aircraft after the aircraft lands on the water. The door release mechanism generally includes a severable linkage that releases from the door prior to inflation of the flotation device. Such severable linkage typically includes a cartridge-activated device to generate the mechanical force required to the fracture the severable linkage.

Such conventional methods and systems have generally been considered satisfactory for their intended purpose. However, there is still a need in the art for an improved severable link that allows for ease of maintenance, servicing, handling, and improved logistics. The present disclosure provides a solution for this need.

### SUMMARY OF THE INVENTION

A de-linking assembly includes an actuator defining a chamber with an inlet, a piston slideably disposed within the chamber, a link coupled to the actuator, and a ram disposed between the piston and the link. The link defines a stress concentration feature and a load point on a side of the link on a side of the stress concentration feature opposite the actuator. The ram is seated between the piston and the load point such that air introduced into the chamber through the inlet applies force to the piston and the ram sufficient to sever the link by inducing stress in the stress concentration feature.

In certain embodiments the actuator can include an outlet. The piston can have a first and second positions within the chamber. In the first position the piston can fluidly isolate the inlet from the outlet. In the second position the inlet can be in fluid communication with the outlet. The de-linking device can define a longitudinal axis, and the outlet can be defined on the actuator at a location disposed between the inlet and the link. It is contemplated that the actuator can include a piston stop disposed within the chamber and between the outlet and the link relative to the longitudinal axis.

In accordance with certain embodiments a face of the piston opposite the link can bound a primary actuation chamber, and a face of the piston facing the link can bound a secondary actuation chamber. The piston can be a primary actuation piston, and the actuator can include a secondary actuation piston slideably disposed within the chamber. The secondary actuation piston can be disposed within the secondary actuation chamber, and a secondary ram can be seated between the secondary actuation piston and the link load point. It is contemplated that inlet and the outlet can be a primary inlet and a primary outlet, and the actuator can define a secondary inlet and a secondary outlet. The secondary inlet can be defined between the primary outlet and the link, and the secondary outlet can be defined between the secondary inlet and the link relative to the longitudinal axis of the assembly.

In accordance with certain embodiments, the link can define a ramway extending between a link aperture disposed on an end of the link coupled to the actuator and the load point. The stress concentration feature can be disposed along the ramway, and can define a link cross-sectional area that is smaller than link cross-sectional areas defined between the load point and the actuator. The primary ram can be disposed within the ramway, and can extend from the primary actuation piston, through the aperture, and through the stress concentration feature such that it abuts the load point. The secondary ram can also be disposed within the ramway, and can extend from the secondary actuation piston, through the aperture, and through the stress concentration feature such that it abuts the load point. The primary ram and secondary ram can be coaxial with one another, the secondary ram circumferentially surrounding the primary ram or the primary ram surrounding the secondary ram for example.

In an aspect, a de-linking system includes an actuator with primary and secondary pistons and a link as described above. In certain embodiments, a compressed gas source can be connected to the inlet. A flotation device can be connected to the actuator outlet. A check valve can be connected between the gas source and the inlet. Alternatively or additionally, a check valve can be connected between the outlet and the flotation device. It is contemplated that the gas source can be connected in series with the flotation device through the inlet and the outlet, and the gas source can be disposed within an airframe of a rotorcraft.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail below with reference to certain figures, wherein:

FIG. 1 is a perspective view of an exemplary embodiment of a rotorcraft constructed in accordance with the present disclosure, showing a rotorcraft with inflated flotation devices;

FIG. 2 is a perspective view of the rotorcraft shown in FIG. 1, showing a flotation device stowed on a landing gear door coupled to the aircraft coupled with a severable link;

FIG. 3 is a perspective view of the severable link assembly of FIG. 1, showing a severable link connected to a pneumatic actuator;

FIG. 4 is cross-sectional side view of the severable link assembly of FIG. 1, showing redundant actuation elements disposed within the housing and coupled to the severable link; and

FIG. 5 is a schematic view of a de-linking system including the severable link assembly of FIG. 1, showing the severable link assembly connected in series between the flotation device compressed gas sources and the flotation devices, according to an embodiment.

### DETAILED DESCRIPTION OF THE PREFERRED EMBODIMENTS

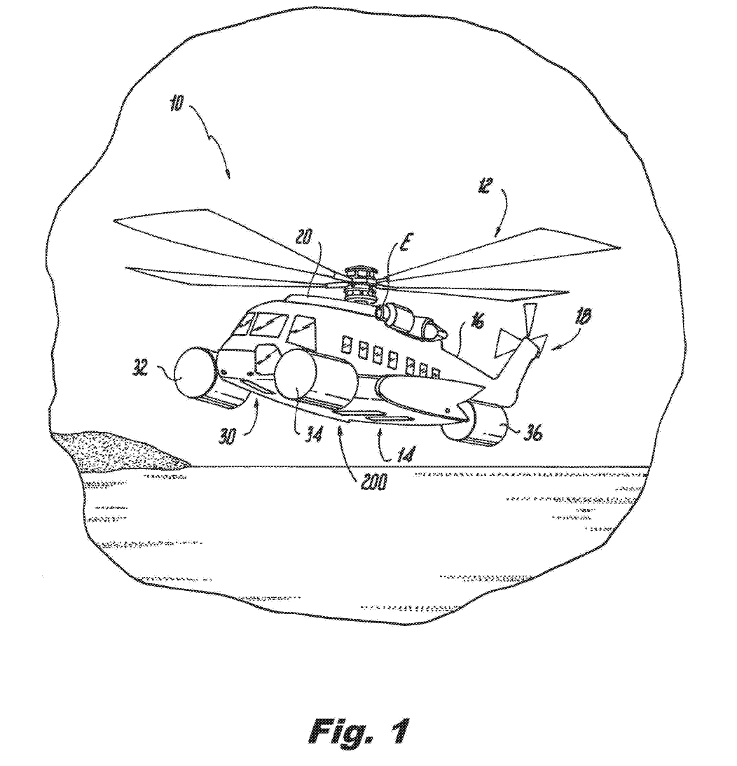

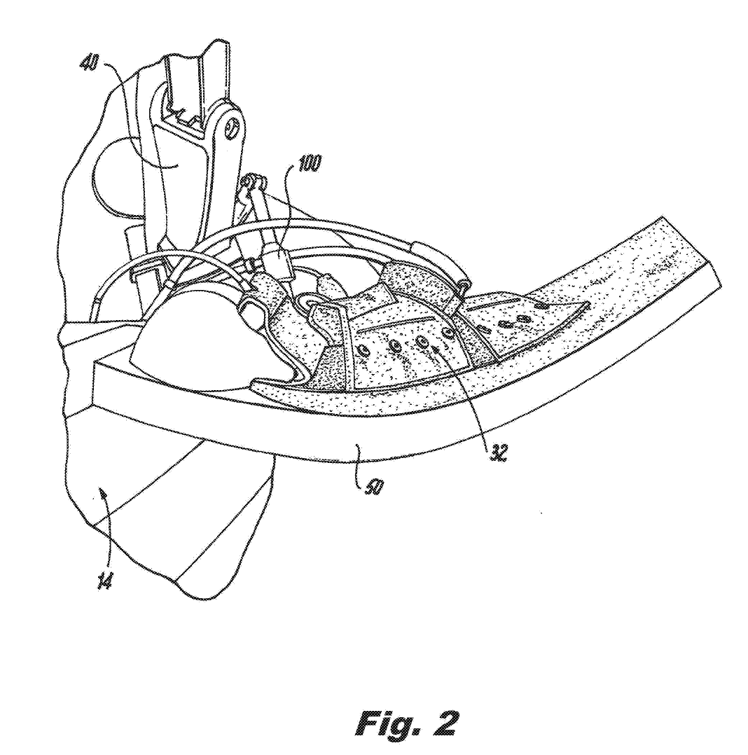

Reference will now be made to the drawings wherein like reference numerals identify similar structural features or aspects of the subject disclosure. For purposes of explanation and illustration, and not limitation, a partial view of an exemplary embodiment of a de-linking system in accordance with the disclosure is shown in FIG. 1 and is designated generally by reference character 200. Other embodiments of de-linking devices and de-linking systems in accordance with the disclosure, or aspects thereof, are provided in FIGS. 2-5, as will be described. The systems and methods described herein can be used in rotary wing aircraft, such as in aircraft flotation deployment systems.

With reference to FIG. 1, a rotorcraft 10 is shown. Rotary-wing aircraft 10 includes a main rotor system 12, an airframe 14 with a longitudinally extending tail 16, and a tail rotor system 18 such as an anti-torque system mounted to tail 16. Main rotor assembly 12 is driven through a main power transmission gearbox 20 by one or more engines E. Main power transmission gearbox 20 carries torque from the engines E through a multitude of gear train paths to main rotor system 12. Although a particular helicopter configuration is illustrated and described in the disclosed embodiment, other configurations and/or machines, such as ground vehicles, general aviation piston aircraft, jet aircraft, turbofan engines, high speed compound rotary wing aircraft with supplemental translational thrust systems, dual contra-rotating, coaxial rotor system aircraft, turbo-props, tilt-rotors and tilt-wing aircraft, will also benefit from the present invention.

Rotorcraft 10 includes a flotation system 30. Flotation system 30 includes de-linking system 200 and a plurality of flotation devices, the illustrated exemplary embodiment including a forward starboard side flotation device 32, a forward port side flotation device 34, and an aft floatation device 36 with inflated (shown) and deflated states (shown in FIG. 2). In the inflated state, the plurality of flotation devices are operable to provide suitable buoyancy and stability to rotorcraft 10 subsequent to a water landing.

With reference to FIG. 2, forward starboard side flotation device 32 is shown in a deflated state. Forward starboard side flotation device 32 is coupled to a landing gear door 50. Landing gear door 50 is pivotably connected to airframe 14 and coupled to landing gear 40 through de-linking assembly 100 such that, when linked, stowing the landing gear 40 closes the landing gear door 50, and deploying the landing gear 40 opens the landing gear door 50. As will be appreciated, it is desirable that landing gear door 50 be free to pivot away from airframe 14 upon inflation of forward starboard side flotation device 32. Accordingly, de-linking system 200 (shown in FIG. 1) is configured to de-couple landing gear door 50 from landing gear 40 by severing de-linking assembly 100 prior to inflation of forward starboard side flotation device 32.

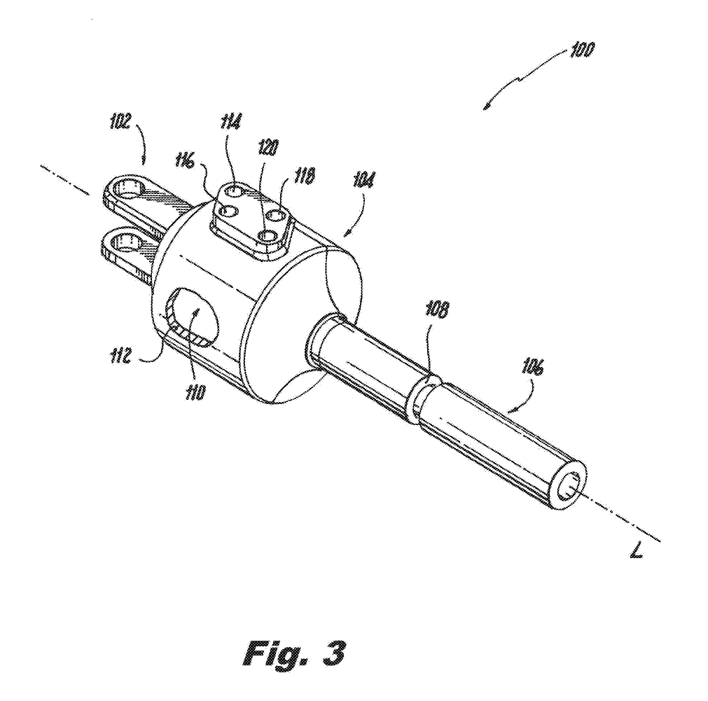

With reference to FIG. 3, de-linking assembly 100 is shown. De-linking assembly 100 includes a yoke 102, an actuator 104, and a severable link 106. Actuator 104 is coupled between the severable link 106 and yoke 102. Actuator 104 defines within its interior a chamber 110 that is bounded by a housing 112. Severable link 106 defines a longitudinal axis L and a stress concentration feature 108 along a length of severable link 106. Stress concentration feature 108 includes a necked-down segment along the length of severable link 106, i.e. an area of minimum cross-sectional area, such that tension applied to severable link 106 may create a stress greater than the ultimate strength of the material forming the severable link 106. This causes severable link to fail in a predictable way at stress concentration feature 108 upon application of a predetermined tensile load on severable link 106.

Housing 112 defines a primary inlet 114, a primary outlet 116, a secondary inlet 118, and a secondary outlet 120 that are each in fluid communication with chamber 110. Primary inlet 114 is disposed along longitudinal axis L on an end of actuator 104 opposite severable link 106. Primary outlet 116 is disposed between primary inlet 114 and severable link 106 adjacent to primary inlet 114. Secondary inlet 118 is disposed between primary outlet 116 and severable link 106 adjacent to primary outlet 116. Secondary outlet 120 is disposed between secondary inlet 118 and severable link 106.

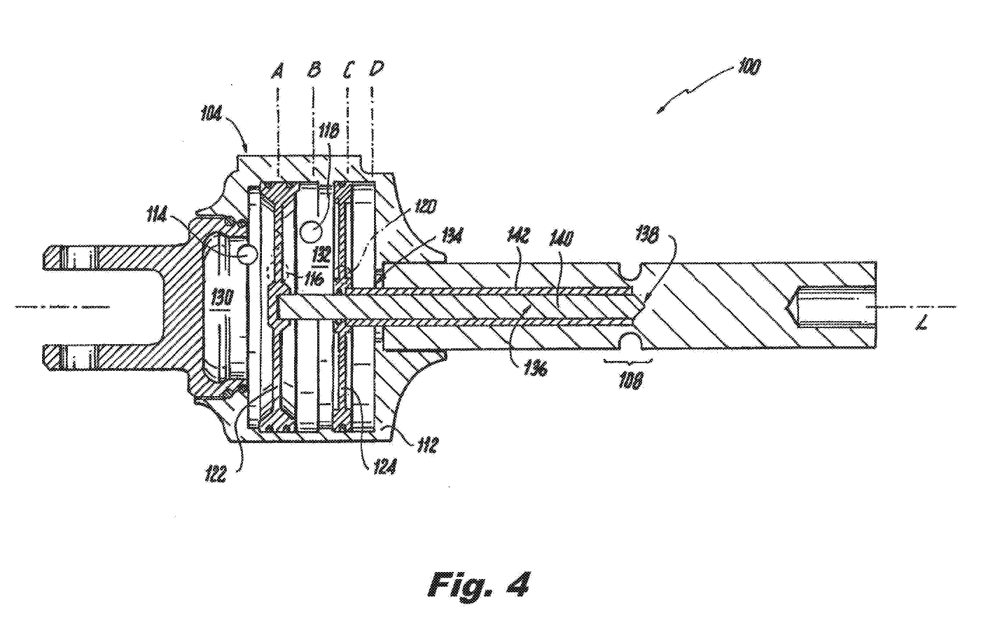

With reference to FIG. 4, de-linking assembly 100 is shown in cross-section. De-linking assembly 100 includes a primary piston 122 and a secondary piston 124 slideably disposed within chamber 110. A portion of the interior of housing 112 and a face of primary piston 122 opposite severable link 106 defines a primary chamber 130. A portion of the interior of housing 112, a face of primary piston 122 facing severable link 106 define a secondary chamber 132.

Primary piston 122 has a first a position A and a second position B, and is axially displaceable from first position A to second position B along longitudinal axis L and towards severable link 106. When primary piston 122 is in first position A, primary inlet 114 is fluidly isolated from primary outlet 116. When primary piston 122 is in second position B, primary inlet 114 is in fluid communication with primary outlet 116. Secondary piston 124 also has a first a position C and a second position D, and is axially displaceable from first position C to second position D along longitudinal axis L towards severable link 106. When secondary piston 124 is in first position C, secondary inlet 118 is fluidly isolated from secondary outlet 120. When secondary piston 124 is in second position D, secondary inlet 118 is in fluid communication with secondary outlet 120. Primary chamber 130 and secondary chamber 132 are each variable volume chambers, respective volumes of each chamber being dependent upon the positions of the pistons.

Severable link 106 defines a ramway 136. Ramway 136 extends from an aperture 134 disposed on an end of severable link 106 adjacent actuator 104, through stress concentration feature 108, to a load point 138 along longitudinal axis L. A primary ram 140 is disposed within ramway 136 and extends between primary piston 122 and load point 138. A secondary ram 142 is also disposed within ramway 136, extends between secondary piston 124 and load point 138, and has a hollow interior within which primary ram 140 is slideably disposed. Ends of primary piston 122 and secondary piston 124 abut a surface defined by load point 138 such that force transmitted through primary piston 122 and secondary piston 124 induces stress within stress concentration feature 108 for fracturing severable link when the stress exceeds a yield strength of the material.

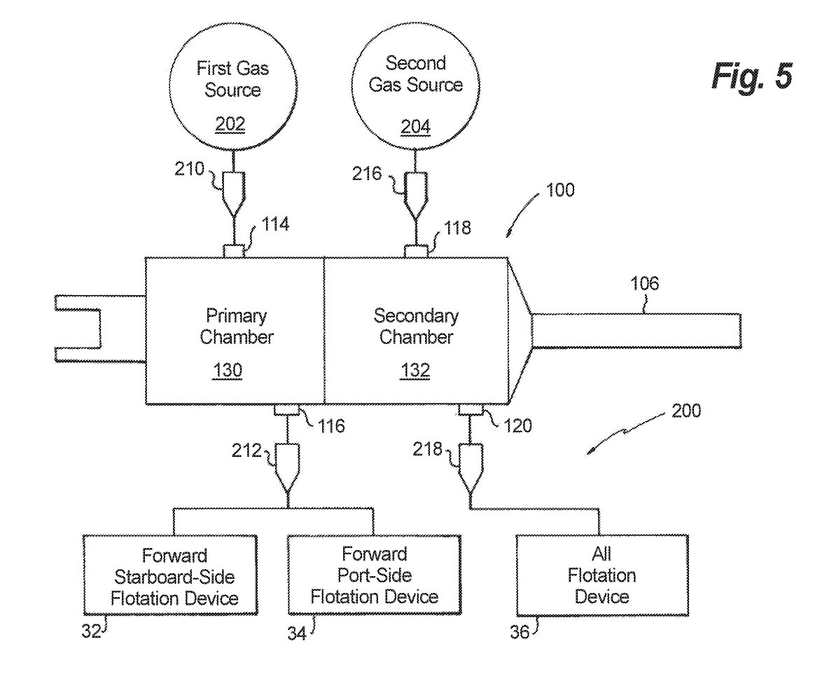

With reference to FIG. 5, de-linking system 200 is shown. De-linking system 200 includes de-linking assembly 100, a first gas source 202, and a second gas source 204. First gas source 202 is connected to a primary chamber 130 through primary inlet 114. A primary inlet check valve 210 is connected between first gas source 202 and primary inlet 114 and is configured to oppose gas flow from primary chamber 130 to first gas source 202. Second gas source 204 is connected to a secondary chamber 132 through secondary inlet 118. A secondary inlet check valve 216 is connected between second gas source 204 and secondary inlet 118 and is configured to oppose gas flow from secondary chamber 132 to second gas source 204.

Forward starboard side flotation device 32 and forward port side flotation device 34 are both connected to primary chamber 130 through primary outlet 116. A primary outlet check valve 212 is connected between primary outlet 116 and both forward starboard side flotation device 32 and forward port side flotation device 34, and is configured to oppose fluid flow from the flotation devices to primary chamber 130. Aft flotation device 36 is connected to secondary chamber 132 through secondary outlet 120. A secondary outlet check valve 218 is connected between secondary outlet 120 and aft flotation device 36 and is configured to oppose fluid flow from aft flotation device 36 to secondary chamber 132. As will be appreciated, de-linking system 200 may have more than three flotation devices, as suitable for an intended application.

Upon actuation, compressed gas flows from either or both of first gas source 202 and second gas source 204 into primary actuation chamber 130 through primary inlet 114 and into secondary actuation chamber 132 through secondary inlet 118. This causes stress within stress concentration feature 108 (shown in FIG. 4) to increase to a level where it exceeds the ultimate strength of material forming severable link 106, at which point the stress causes severable link 106 to fracture. Fracture of severable link 106 permits primary piston 122 and secondary piston 124 to displace axially along longitudinal axis L, placing primary inlet 114 in fluid communication with primary outlet 116 and secondary inlet 118 in fluid communication with secondary outlet 120.

Fluid communication of primary inlet 114 and primary outlet 116 allows compressed gas to traverse primary outlet check valve 212, enter both forward starboard side flotation device 32 and forward port side flotation device 34, and inflate both forward starboard side flotation device 32 and forward port side flotation device 34. Similarly, fluid communication of secondary inlet 118 and secondary outlet 120 allows compressed gas from second gas source 204 to traverse secondary outlet check valve 218, enter aft flotation device 36, and inflate aft flotation device 36. Because severable link 106 severs prior to fluid communication occurring, inflation occurs with landing gear door 50 disconnected, and the respective flotation device inflates external to the aircraft.

Some aircraft include severable linkages that employ explosive charges to sever the link coupling the landing gear door and the landing gear upon activation of the flotation system. While satisfactory for their intended purpose, such severable linkages can pose maintenance and logistical problems due to the explosive charges included in such severable linkages. Such severable linkages can also require independent control systems, may have a limited lifetime dictated by the stability of the explosive material incorporated in the severable linkage, and are generally non-repairable. They can also require replacement after usage or upon expiration.

In embodiments described herein, dc-linking devices employ a pneumatic actuator and compressed gas to sever the link coupling the landing gear door and landing gear upon activation of the flotation system. In certain embodiments, the compressed gas used to inflate the flotation devices actuated the severable link actuator, thereby eliminating the need for the aircraft to incorporate an independent source of mechanical energy to sever the link. Upon actuation, compressed gas issues from the compressed gas source and into the chambers of the actuator, pressurizing the chambers. Pressurization of the chambers generates stress within the severable link stress feature, fracturing the link, and placing the chambers in fluid communication with flotation devices and providing the flotation devices access to the environment external to the aircraft. This allows the compressed air to flow in to the flotation devices, inflating the flotation devices while coupled to aircraft on the aircraft airframe exterior.

In accordance with certain embodiments, check valves direct the compressed gas into the actuator chambers redundantly, allowing the gas pressure to apply force to the severable link load point sufficient to apply tensile stress to the stress concentration feature in excess of the yield strength of the material, thereby causing the link to separate at the stress concentration feature.

The methods and systems of the present disclosure, as described above and shown in the drawings, provide for severable links with superior properties including inert actuation. While the apparatus and methods of the subject disclosure have been shown and described with reference to preferred embodiments, those skilled in the art will readily appreciate that changes and/or modifications may be made thereto without departing from the scope of the subject disclosure, such as by omitting the check valves or changing the arrangement of the flotation devices.

1. A de-linking assembly, comprising:
an actuator defining a chamber with an inlet;
a piston slideably disposed within the chamber;
a link coupled to the actuator and defining a stress concentration feature; and
a ram disposed between the piston and a load point on a side of the link opposite the stress concentration feature.

2. A de-linking assembly as recited in claim 1, wherein the piston is configured to transfer force from a pressurized fluid introduced into the chamber through the inlet to the load point through the ram for severing the link.

3. A de-linking assembly as recited in claim 1, wherein the actuator further defines an outlet disposed between the inlet and the link.

4. A de-linking assembly as recited in claim 3, wherein the piston has first and second positions, the inlet being fluidly isolated from the outlet when the piston is in the first position, the inlet being in fluid communication with outlet when the piston is in the second position.

5. A de-linking assembly as recited in claim 1, further comprising a piston stop interposed within the chamber between the outlet and the link.

6. A de-linking assembly as recited in claim 1, wherein the piston divides the chamber into a primary actuation chamber disposed on a side of the piston opposite the link and a secondary actuation chamber disposed on a side of the piston facing the link between the piston and the link.

7. A de-linking assembly as recited in claim 1, wherein the piston is a primary actuation piston, and further including a secondary actuation piston slideably disposed within the chamber between the primary piston and the link.

8. A de-linking assembly as recited in claim 7, wherein the ram is a primary ram, and further including a secondary ram disposed between the secondary piston and the load point.

9. A de-linking assembly as recited in claim 8, wherein the secondary ram is coaxial with the primary ram.

10. A de-linking assembly as recited in claim 8, wherein at least one of the primary and secondary rams are disposed within an interior of the link.

11. A de-linking assembly as recited in claim 8, wherein the primary ram extends through a center of the secondary ram and along a longitudinal axis defined by the link.

12. A de-linking assembly as recited in claim 1, wherein the inlet is a primary inlet, wherein the actuator defines a secondary inlet disposed between the primary inlet and the link.

13. A de-linking assembly as recited in claim 12, wherein the actuator further defines a primary outlet, wherein the primary outlet is disposed between the primary inlet and the secondary inlet relative to an axis defined by the de-linking assembly.

14. A de-linking assembly as recited in claim 12, wherein the actuator further defines a secondary outlet, wherein the secondary outlet is disposed between the secondary inlet and the link relative to an axis defined by the de-linking assembly.

15. A de-linking system, comprising:
an actuator defining a chamber with an inlet;
a link coupled to the actuator and defining a stress concentration feature;
a primary piston slideably disposed within the chamber between the inlet and the link;
a secondary piston slideably disposed within the chamber between the primary piston and the link;
a primary ram disposed between the primary piston and a load point on a side of the link opposite the stress concentration feature; and
a secondary ram disposed between the secondary piston and the load point and circumferentially surrounding the primary ram.

16. A de-linking system as recited in claim 15, wherein one of the primary and secondary rams is configured to transfer force from a pressurized fluid introduced into the chamber through the inlet to the load point through the ram for severing the link.

17. A de-linking system as recited in claim 15, further comprising a compressed gas source connected to the inlet.

18. A de-linking system as recited in claim 15, further comprising a check valve connected to the inlet and configured to oppose fluid flow from the inlet through the check valve.

19. A de-linking system as recited in claim 15, wherein the chamber defines an outlet and further including a flotation device connected to the outlet.

20. A de-linking device as recited in claim 18, further including a check valve connected between the outlet and the flotation device and configured to oppose fluid flow from the flotation device to the outlet.
